(19) United States
(12) Patent Application Publication
(10) Pub. No.: US 2006/0230396 A1
(43) Pub. Date: Oct. 12, 2006

(54) Deployment of reusable software components to be hosted in a container running on a modular code runtime platform through a runtime platform extension point

(75) Inventors: Melaquias E. Martinez, Boylston, MA (US); Sheldon Y. Chan, Somerville, MA (US); Andrew E. Davis, Arlington, MA (US); Keith A. Kimball, Hollis, NH (US)

Correspondence Address: Steven M. Greenberg, Esquire;Christopher & Weisberg, P.A., Suite 2041, 200 East Las Olas Boulevard, Fort Lauderdale, FL, 33301, US

(73) Assignee: International Business Machines Corporation, Armonk, NY (US)

(21) Appl. No.: 11/101,105

(22) Filed: Apr. 7, 2005

(51) Int. Cl. G06F 9/44

(52) U.S. Cl. 717/173

(57) ABSTRACT

In a modular code runtime environment, a reusable software component deployment system can include a reusable software component container, a registry of reusable software components slated for deployment in the container, and a deployment plug-in to the modular code runtime environment coupled to the registry. The deployment component can include an extension point configured for use by other plug-ins including reusable software components slated for deployment in the container. In one aspect of the invention, the reusable software components can include enterprise beans. In this regard, each of the other plug-ins can include a bundle of enterprise beans and a manifest referencing the extension point and listing the enterprise beans which are to be registered in the registry through the deployment plug-in. Finally, the modular code runtime platform can be the Eclipse integrated development environment.

### BACKGROUND OF THE INVENTION

1. Statement of the Technical Field

The present invention relates to deployment of componentized application logic in an application framework and more particularly to the deployment of a reusable software component in a modular code runtime environment.

2. Description of the Related Art

Enterprise application servers are application frameworks for deploying componentized application logic and services. In particular, enterprise application servers provide a common framework and re-usable set of underlying services to componentized application logic. Generally, componentized application logic can include reusable software components. Examples of reusable software components include visual components manufactured by Borland Software Corporation of Scotts Value, Calif., and the venerable bean ordinarily associated with the Java programming language.

An enterprise form of the bean is a Java 2 Platform, Enterprise Edition (J2EE) platform component that implements enterprise Java bean (EJB) technology. Specifically, an enterprise bean is a server-side component that encapsulates the business logic of an application. The business logic is the code that fulfills the purpose of the application. By invoking these methods, remote clients can access the inventory services provided by the application. Notably, enterprise beans run in an EJB container, a runtime environment within the J2EE server. Although transparent to the application developer, the EJB container provides system-level services such as transactions to its enterprise beans. These services enable the developer to quickly build and deploy enterprise beans, which form the core of transactional J2EE applications.

In the J2EE environment, the deployment and registration of EJBs can be accomplished in an EJB container through a vendor specific user interface or customized application installation process. Yet, the process of integrating an EJB container within a modular code runtime platform can be granular and clumsy. Specifically, in a modular code runtime platform, such as the Eclipse integrated development environment, maintained by the Eclipse Foundation, integrating an EJB container to handle the deployment of corresponding EJBs can require the manual tooling of the integration process to accommodate the nature of different plug-ins to the modular code runtime environment.

Accordingly, when integrating an EJB container into a modular code runtime platform such as the Eclipse platform, it would be desirable to provide an aggregation/registration mechanism that enables deployment of EJBs using the modular code framework of the host platform. That is, it would be helpful if one could package the EJBs using the modular code format supported by the host platform. In this way, the developer could be relieved of the clumsy, manual process of integrating EJB containers into the modular code runtime platforms.

### SUMMARY OF THE INVENTION

The present invention addresses the deficiencies of the art in respect to integrating a reusable software component container into a modular code runtime platform, and provides a novel and non-obvious method, system and apparatus for reusable software component deployment in a modular code runtime platform. Utilizing the method, system and apparatus of the present invention, an aggregation/registration mechanism is provided that enables deployment of reusable software components using the modular code framework of the host platform. Furthermore, in the present invention the reusable software components can be packaged using a modular code format supported by the host platform. In this way, the developer can be relieved of the clumsy, manual process of integrating containers into the modular code runtime platforms.

In a modular code runtime environment, a reusable software component deployment system can include a reusable software component container, a registry of reusable software components slated for deployment in the container, and a deployment plug-in to the modular code runtime environment coupled to the registry. The deployment component can include an extension point configured for use by other plug-ins including reusable software components slated for deployment in the container. In one aspect of the invention, the reusable software components can include enterprise beans. In this regard, each of the other plug-ins can include a bundle of enterprise beans and a manifest referencing the extension point and listing the enterprise beans which are to be registered in the registry through the deployment plug-in. Finally, the modular code runtime platform can be the Eclipse integrated development environment.

A method for deploying reusable software components in a modular code runtime environment can include identifying one or more reusable software components to be deployed in a container in the modular code runtime environment. The method further can include registering the reusable software components in a registry in the modular code runtime environment. Finally, the method can include deploying registered ones of the reusable software components into the container in the modular code runtime environment.

In one aspect of the invention, the identifying step can include exposing an extension point to a plug-in to the modular code runtime environment and receiving extensions to the exposed extension point. Specifically, each extension can specify one or more reusable software components to be deployed in a container in the modular code runtime environment. The receiving step in turn can include parsing a manifest for a bundle for each extension. The bundle can include archived reusable software components, while the manifest can list the archived reusable components and further can reference the extension point.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the this description, serve to explain the principles of the invention. The embodiments illustrated herein are presently preferred, it being understood, however, that the invention is not limited to the precise arrangements and instrumentalities shown, wherein:

FIG. 1 is a schematic illustration of a modular code runtime platform configured for bean deployment through an extension point; and,

FIG. 2 is a flow chart illustrating a process for bean deployment in a modular code runtime platform through an extension point.

### DETAILED DESCRIPTION OF THE PREFERRED EMBODIMENTS

The present invention is a method, system and apparatus for reusable software component deployment in a modular code runtime platform through an extension point. In accordance with the present invention, a reusable software component deployment plug-in can be installed into the modular code runtime platform. The deployment plug-in can expose an extension point for registering reusable software components for deployment in a reusable software component container. Consequently, other plug-ins can utilize the extension point to register reusable software components for deployment. During startup of the modular code runtime platform, the deployment plug-in can refer to the registry to identify reusable software components slated for deployment and to manage the verification and deployment of the registered reusable software components into the container.

The skilled artisan will recognize several advantages of the foregoing arrangement. First, the modular code runtime platform can become a host for a reusable software component container that can be updated and modified by provisioning plug-ins to change which reusable software components execute in the container. Also, the reusable software component container of the modular code runtime platform can provide a local, client-side execution context for reusable software components that would normally be remotely accessed by a client. Hence, substantial off-line processing of client-server applications can be enabled within the modular code runtime platform in consequence of the present invention.

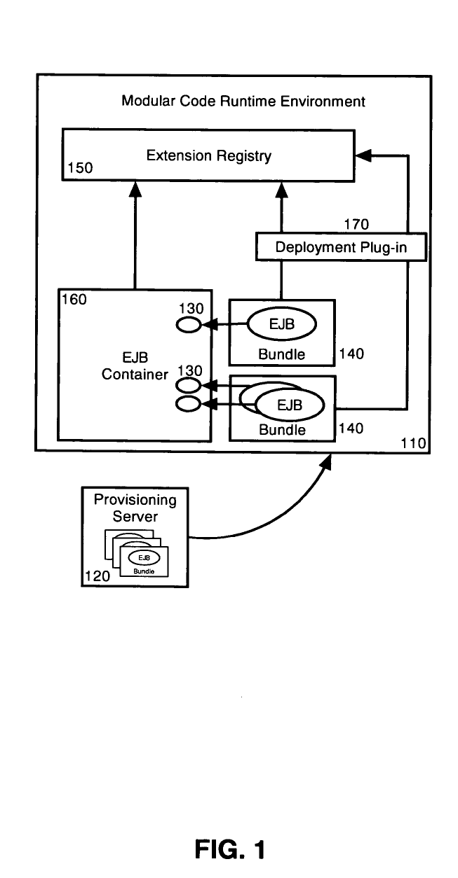

In further illustration of the present invention, FIG. 1 is a schematic illustration of a modular code runtime platform configured for reusable software component deployment through an extension point. As shown in FIG. 1, an extension registry 150 can be disposed in a modular code runtime platform 110. The modular code runtime environment 110 can expose an extension point for use by one or more provisioning servers 120 in deploying reusable software components 130 to a bean container 160 operating within the modular code runtime environment 110. As an example, the reusable software components can include EJBs in a J2EE environment.

Optionally, a deployment plug-in 170 can include logic programmed to write entries in the extension registry 150 for reusable software components 130 which are to be deployed in the reusable software component container 160. To determine which reusable software components 130 are to be deployed, the deployment plug-in 170 also can include logic programmed to parse provisioned plug-in bundles 140. Each of the bundles can contain one or more of the reusable software components 130 and a manifest (not shown) declaring not only the presence of the reusable software components 130, but also the extension point exposed by the deployment plug-in 170.

For instance, where the reusable software component is an EJB, a manifest pointing to the extension point “org.example.bean.platform.providers” for the modular code runtime platform “org.example.bean.platform” which identifies for deployment the bean “examplebean1” included in the archive “examplebean.jar” can include:

<extension id=“org.example.bean.example_beans”

name=“Provider for Bean Example”
point=“org.example.bean.platform.providers”>

<bean name=“Example Bean”

uri=“deploy\examplebean.jar”
id=“org.example.bean.examplebean1”>

</bean>

</extension>

While parsing the manifest for each of the plug-in bundles 140, the deployment plug-in 170 can identify reusable software components 130 to be deployed in the container 160 and can write registry entries for each of the identified ones of the reusable software components 130. Subsequently, during the startup of the modular code runtime platform 110, the container 160 can process the extension registry 150 to identify the reusable software components 130 slated for deployment. Once identified, the reusable software components 130 can be located and loaded into the container 160 for operation within the modular code runtime environment 110.

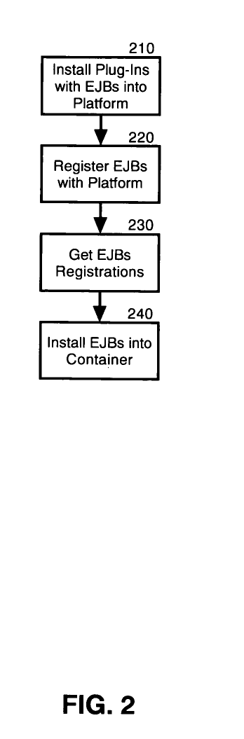

In further illustration of the process of the invention, FIG. 2 is a flow chart illustrating a process for reusable software component deployment in a modular code runtime platform through an extension point. Beginning in block 210, each plug-in contain reusable software components to be deployed into the modular code runtime environment can be installed into the modular code runtime environment. In block 220, upon installation, the reusable software components in each plug-in can be registered in the extension registry of the modular code runtime environment. In block 230, the reusable software component container can observe the registrations and in block 240, using the registry information, the container can load the reusable software components referred to in the registry into the container.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. In a modular code runtime environment, a reusable software component deployment system comprising:
a reusable software component container;
a registry of reusable software components slated for deployment in said container; and,
a deployment plug-in to the modular code runtime environment coupled to said registry and comprising an extension point configured for use by other plug-ins comprising reusable software components slated for deployment in said container.

2. The system of claim 1, wherein said reusable software components comprise enterprise beans.

3. The system of claim 1, wherein each of said other plug-ins comprises a bundle of enterprise beans and a manifest referencing said extension point and listing said enterprise beans which are to be registered in said registry through said deployment plug-in.

4. The system of claim 1, wherein the modular code runtime platform is the Eclipse integrated development environment.

5. A method for deploying reusable software components in a modular code runtime environment, the method comprising the steps of:
identifying a plurality of reusable software components to be deployed in a container in the modular code runtime environment;
registering said plurality of reusable software components in a registry in the modular code runtime environment; and,
deploying registered ones of said reusable software components into said container in the modular code runtime environment.

6. The method of claim 5, wherein said identifying step comprises the steps of:
exposing an extension point to a plug-in to the modular code runtime environment; and,
receiving extensions to said exposed extension point, each extension specifying a plurality of reusable software components to be deployed in a container in the modular code runtime environment.

7. The method of claim 6, wherein said receiving step comprises the step of parsing a manifest for a bundle for each extension, said bundle comprising a plurality of archived reusable software components, said manifest listing said archived reusable components and referencing said extension point.

8. The method of claim 5, wherein said reusable software components comprise enterprise beans.

9. The method of claim 5, wherein the modular code runtime platform is the Eclipse integrated development environment.

10. A machine readable storage having stored thereon a computer program for deploying reusable software components in a modular code runtime environment, the computer program comprising a routine set of instructions which when executed by a machine causes the machine to perform the steps of:
identifying a plurality of reusable software components to be deployed in a container in the modular code runtime environment;
registering said plurality of reusable software components in a registry in the modular code runtime environment; and,
deploying registered ones of said reusable software components into said container in the modular code runtime environment.

11. The machine readable storage of claim 10, wherein said identifying step comprises the steps of:
exposing an extension point to a plug-in to the modular code runtime environment; and,
receiving extensions to said exposed extension point, each extension specifying a plurality of reusable software components to be deployed in a container in the modular code runtime environment.

12. The machine readable storage of claim 11, wherein said receiving step comprises the step of parsing a manifest for a bundle for each extension, said bundle comprising a plurality of archived reusable software components, said manifest listing said archived reusable components and referencing said extension point.

13. The machine readable storage of claim 10, wherein said reusable software components comprise enterprise beans.

14. The machine readable storage of claim 10, wherein the modular code runtime platform is the Eclipse integrated development environment.
